(19) United States
(12) Patent Application Publication
(10) Pub. No.: US 2011/0258902 A1
(43) Pub. Date: Oct. 27, 2011

(54) Geiboy's bait retriever/hook remover

(76) Inventor: Thad Lagree Cason, Alachua, FL (US)

(21) Appl. No.: 12/932,678

(22) Filed: Mar. 3, 2011

Related U.S. Application Data
(60) Provisional application No. 61/339,590, filed on Mar. 5, 2010.

(51) Int. Cl. A01K 97/18; A01K 97/24

(52) U.S. Cl. 43/17.2; 43/53.5

(57) ABSTRACT

The retriever/hook remover is a device for retrieving fishing lures that have become hung on various objects below and above the surface of the water. It can also be used to remove the hooks from the mouth of the fish after it has been caught.

It consists of a handle that will attach to a standard utility pole. A stiff rod is molded into the handle that attaches to the extension pole. This rod should be made of a rigid metal to ensure that it retains durability, but could possibly be made from other material.

At the end of the rod, opposite the handle, the rod is coiled to encase the fishing line to keep it from escaping. Coiling the rod three times seems to work really well, but the rod could be coiled more or less times. The inside diameter of this coil should be 3/16-inch to maybe 2-inches.

The minimum rod size should be at least 3/16-inch in diameter to give it rigidity and durability. The length can vary from a few inches up to maybe four feet. This would allow for several different sizes to be manufactured to meet the needs of the individual fisherman.

The rod can be made in a straight line from the handle to the coil or it can be bent to approximately a forty-five degree angle. If the rod is bent in this manner it gives the retriever/hook remover the ability to put pressure on the hung lure in a downward position as well as pushing it backwards from the object on which it is hung.

### CROSS REFERENCE TO RELATED APPLICATIONS

This application contains the benefit of provisional patent application Ser. No. 61/339,590, filed 2010 Mar. 5 by the present inventor.

### BACKGROUND

### Prior Art

The following is a tabulation of some prior art that presently appears relevant:

| Patent Number | Title | Issue Date |
|---|---|---|
| 4,395,840 | Telescoping lure dehooker | Aug. 2, 1983 |
| 4,622,772 | Fishing lure retriever | Nov. 18, 1986 |
| 5,216,828 | Fishing tackle retriever system | Jun. 8, 1993 |
| 6,305,119 | Fishing lure retriever | Oct. 3, 2001 |
| 6,694,664 | Fishing lure retriever | Feb. 24, 2004 |

One of the problems often encountered in fishing is the snagging of hooks and lures in inaccessible locations such as on underwater logs, branches, stumps, rocks, or oyster bars. Hooks and lures also get hung on low hanging branches and vines hanging over the water when the fisherman makes an errant cast. Various devices to assist in the retrieval of these hung lures have been developed and many of these devices are described in patents.

These devices of prior arts have various disadvantages.

A. One type of lure retriever employs a weighted knocker type device with a long string or line attached to it. This knocker device is attached to the fishing line and is lowered down the line in a trolley like fashion to knock the lure free from whatever it is hung on. There are several problems with this type of lure retriever.

1. You must be almost directly above the hung lure for the weight to disengage the hung hooks. Many times this is not possible if you are fishing around submerged treetops or other structure.

2. If the lure is hung on a tree limb, root, or rock that is lying on the bottom of the lake or river this type of retriever will not disengage the hung hooks because it hits the bottom first.

B. Some of these weighted lure retrievers have short lengths of chain attached to them.

1. The types of retrievers usually get hung on submerged limbs or other structure before it ever gets to the hung lure.

2. If you do happen to get it down to the hung lure, you then have to jiggle the retriever up and down and hope that it will get caught on one of the hooks on the lure that is not hung on the object that the lure is hung on. This usually proves to be hard to accomplish and time consuming.

3. Most of the time if you are lucky enough to pull the lure free from the object that it is hung on, you will either damage the hook that was hung or the one that was used to pull the lure free. Either way the lure is usually damaged.

4. Neither of these types of lure retrievers can be used to retrieve lures that are hung on objects such a low hanging branches or vines that are above the water.

C. There are several variations of retrievers that are attached to extension poles used to reach these hung lures. These lure retrievers use several different configurations to engage the hung lures and dislodge them. An example of this type retriever is U.S. Pat. No. 6,694,664.

1. Most of those types of retrievers work by putting pressure on the fishing line where it is tied to the lure. This is the weakest point of the line, and makes it vulnerable to break off.

2. All of these devices are permanently attached to the pole on which it is mounted. This makes it limited to one operation in a fishing expedition.

3. Most of these retrievers are to large to retrieve lures that are hung in the tree roots, vines, oyster bars, or rock crevices.

### ADVANTAGES

A. This bait retriever/hook remover is simple to manufacture.
B. It will attach to any standard utility extension pole that is already on the market. These poles can be purchased at most hardware or paint stores. They are primarily used for painting ceilings or washing windows.
C. Most of these standard extension poles use a screw on type adapter to attach their working components. This would be the best way to attach the bait retriever/hook remover, but other ways could be used to attach it to the extension pole.
D. Being able to separate the bait retriever/hook remover from the pole will significantly reduce the cost of replacement if the retriever/hook remover or the extension pole becomes damaged.
E. Using a rigid metal rod molded into a hard plastic or metal handle makes the retriever/hook remover very rugged and hard to damage.
F. The small diameter of the coil allows the retriever/hook remover to be used in tight places such as tree roots, vines, tree branches, rocks and oyster bars to retrieve baits.
G. The rod between the handle and the coil at the end of the rod can be a straight-line or it can be bent. This will enable the retriever to put downward pressure on the hung lure as well as push it backward.
H. The greatest attributes of the lure retriever/hook remover are on the monetary side of the equation.

1. The bait retriever/hook remover is built separate from the extension pole to which it is attached. If you damage the retriever/hook remover or the extension pole to which it is attached, you simply replace the damaged component, which saves the fisherman money.

2. By being built to attach to any standard extension pole, the fisherman can save money on his initial investment if he already owns an extension pole that he may use to paint ceilings or wash windows.

3. When the bait retriever/hook remover is detached from the pole it can be used to remove the hooks from the mouth of the fish after it has been boated.

4. It can also be attached to the extension pole and be used to extract hooks from the mouth of a large•fish while it is still in the water. This enables the fisherman to be farther away from these large and sometimes dangerous fish when they are being released while still in the water.

5. Some of these release mechanism now on the market cost fifty dollars or more. The cost of purchasing a bait retriever/hook remover plus the price of a standard extension pole that can be purchased at any paint store or hardware store should be considerably less than purchasing one of these other release mechanisms.

### SUMMARY

A. The retriever/hook remover will be easy to manufacture because of the simple design.
B. By being able to separate the retriever/hook remover from the extension pole it will cost much less to manufacture.
C. The simple design and being made with a hard plastic handle or metal handle and a rigid metal rod makes it very durable.

### DRAWINGS

### Figures

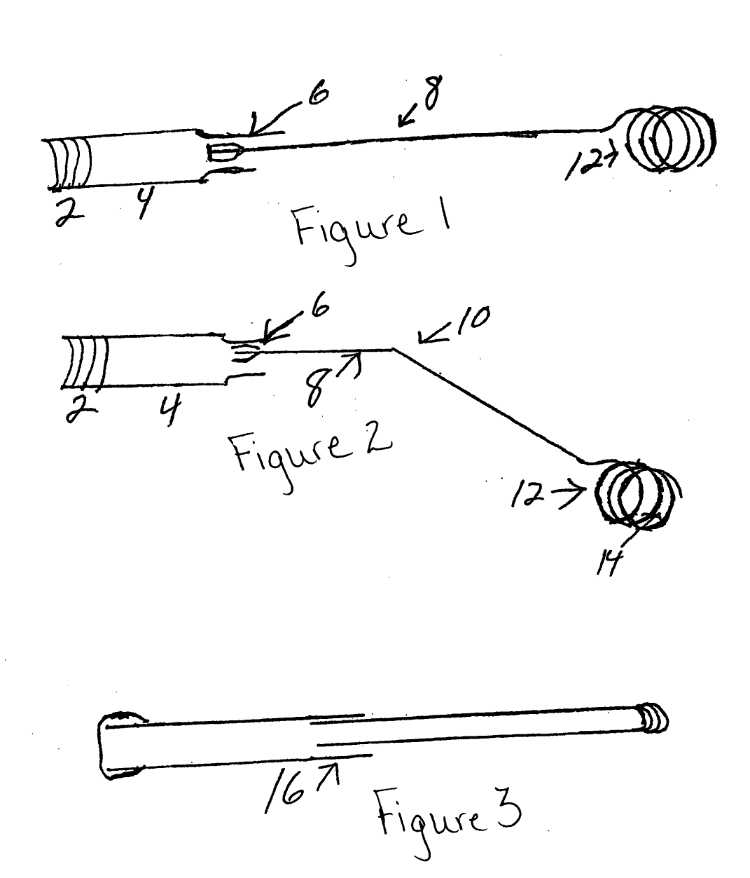

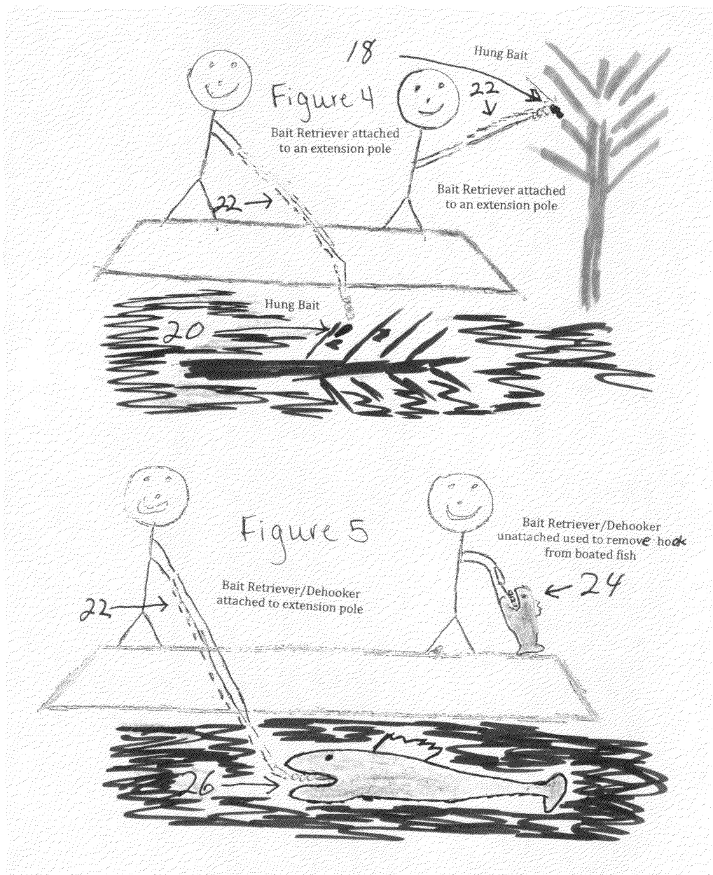

FIGS. 1 and 2 labeled components of Bait Retriever/Hook Remover

FIG. 3 Extension pole extended with threaded end to attach bait retriever/hook remover.

FIGS. 4 and 5 Illustrations on how to use Bait Retriever/Hook Remover

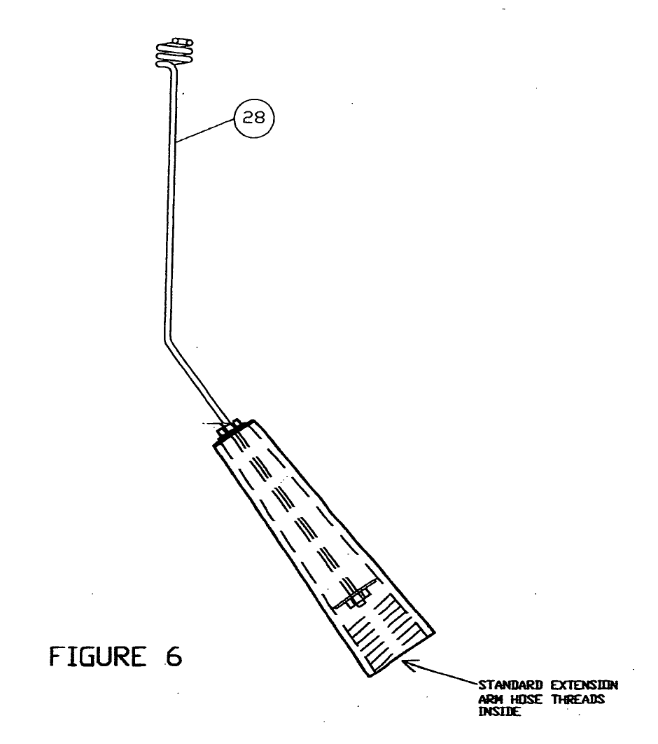

FIG. 6 Small completed Bait Retriever/Hook Remover

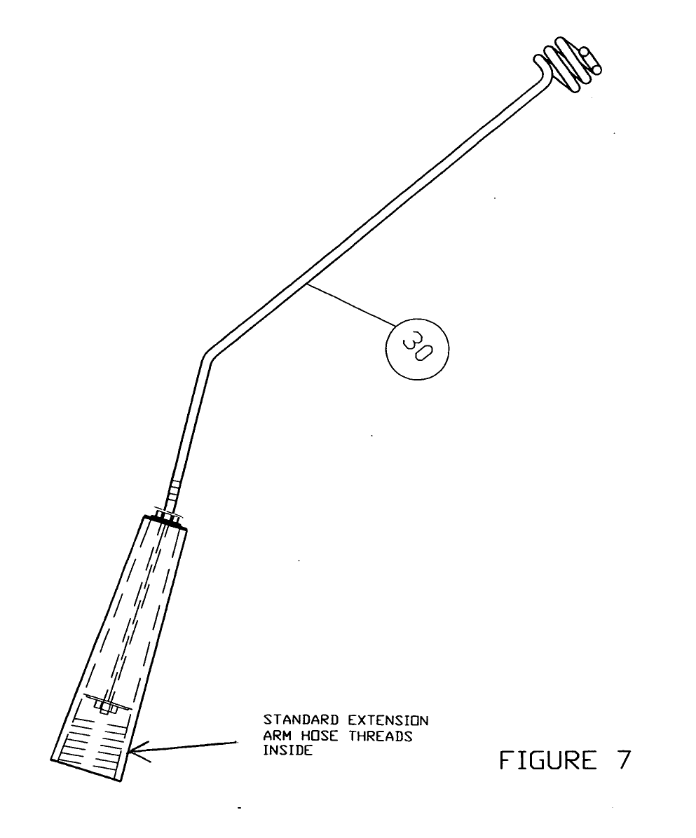

FIG. 7 Larger version of Bait Retriever/Hook Remover

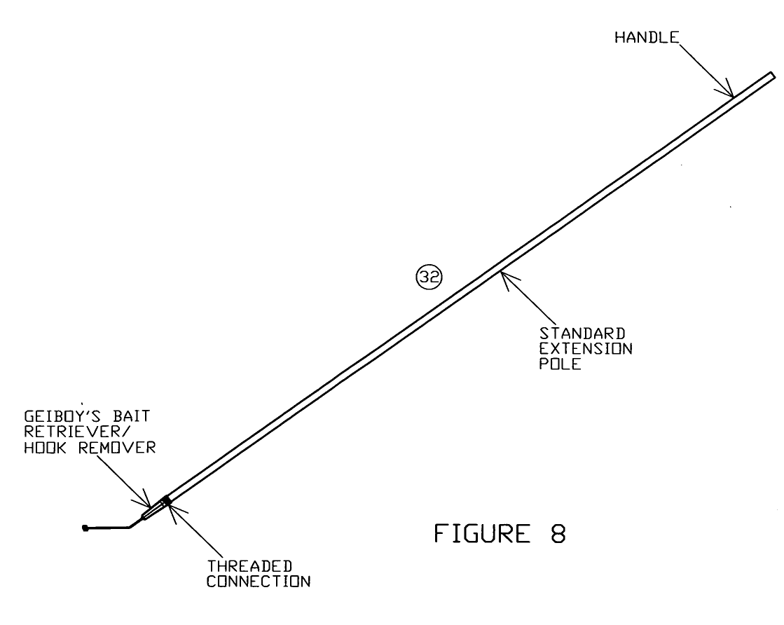

FIG. 8 Bait Retriever/Hook Remover attached to extension pole

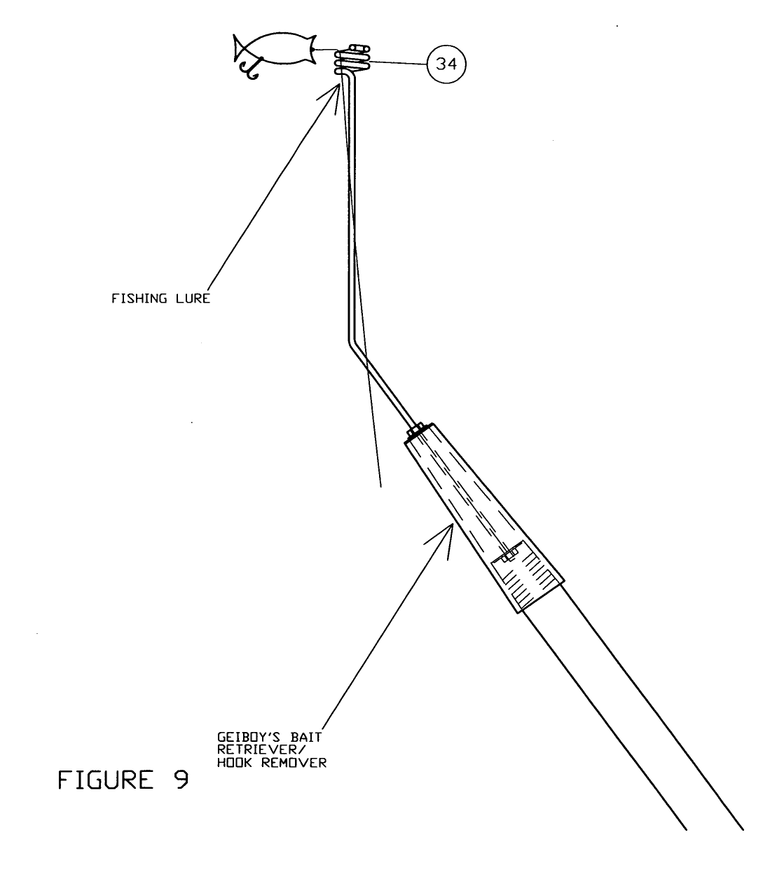

FIG. 9 Small lure engaged in end of coil

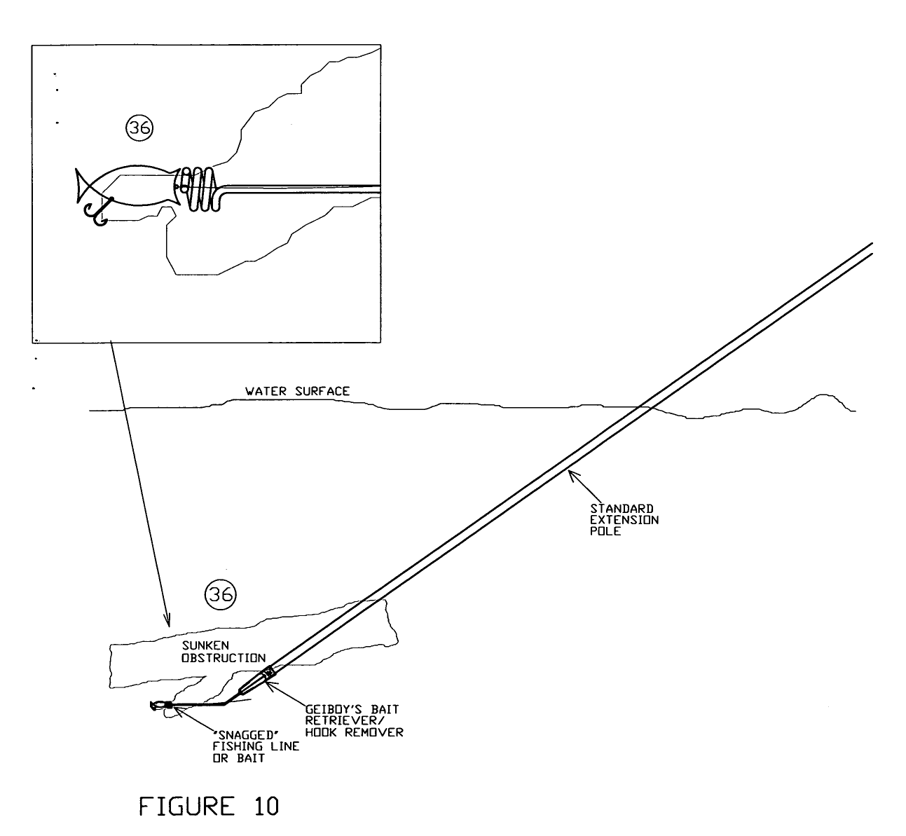

FIG. 10 Shows how bend in the rod allows retriever to curl under log

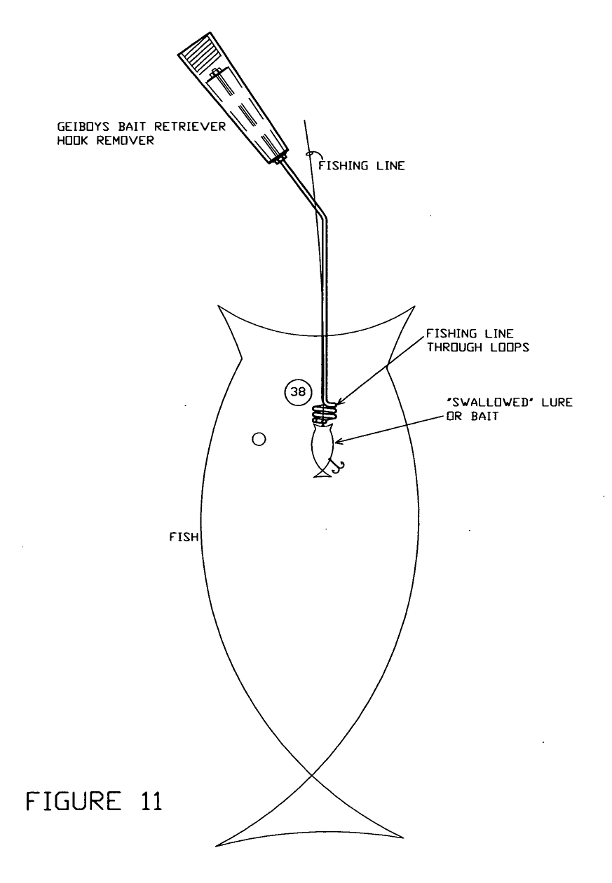

FIG. 11 Photo of retriever being used as a dehooker

### REFERENCE NUMBERS

2—Female threads inside hard plastic or metal screw on handle
4—Hard plastic or metal handle
6—Flange molded inside hard plastic or metal handle to prevent rod from turning
8— 3/16^{th} inch or larger rigid rod
10—Bend in rod to assist in applying downward pressure
12—Coil at end of metal rod approximately ⅜^{th} of an inch inside diameter
14—Adequate space between coils to allow fishing line to be wrapped around coil
16—Any standard extension pole that uses screw on tools
18—Bait is hung on tree limb
20—Submerged tree limbs on which bait is hung
22—Broken line represents fishing line
24—Unattached retriever being used to remove hook/hooks from caught fish
26—Large fish being released in the water
28—Bait retriever/hook remover made with a 3/16^{th} inch metal rod with a ⅜^{th} inch inside diameter in coil
30—Bait retriever/hook remover made with a ¼ inch metal rod with a 1¼ inch inside diameter in coil
32—Bait retriever/hook remover attached to a standard extension pole
34—Small lure being held by ⅜-inch coil
36—Photo shows how bend in rod allows retriever to curl around trunk of tree to push bait downward from the object on which the lure is hung
38—Photo of bait retriever/hook remover being used to remove hook embedded deep in the throat of a bass

### DETAILED DESCRIPTION

A. The bait retriever/hook remover is a rigid metal rod molded into a hard plastic or metal handle that is used to attach to any standard utility extension pole.
B. The diameter of these rods should be large enough to insure that the bait retriever/hook remover is sturdy enough to withstand practical use in exerting a certain amount of pushing or pulling power on the hung lure. A 3/16-inch O.D. rod up to a 5/16-inch rod should be adequate to withstand this pressure. A smaller or larger rod could be used if there proves to be a market for it.
C. The length of the rod can vary from approximately a few inches to 48-inches or more according to the needs and desires of the fisherman.
D. The rod between the handle and the coil on the end of the rod can be kept in a straight line or it can be bent.
E. If the rod is bent between the handle and the coil it tends to put downward pressure on the hung lure as well as pushing it backwards.
F. The bend in the rod also allows the rod handle and much of the rod to be kept out of the mouth of the fish when it is used as a hook remover.
G. The end of the rod should be coiled in three complete turns. This will insure that the fishing line stays completely encased inside the coil while it is being used.
H. The inside diameter of the coil should be approximately 3/16-inches for the smaller version to approximately 2-inches for the larger versions.
I. Keeping the line completely encased inside the coil ensures that the coil will slide up and down the fishing line freely.
J. By keeping the line completely encased inside the coil also ensures that the coil will put pressure on the hung lure or hook that the line is tied to and not on the line where it is tied to the lure or hook. This is the weakest point in the line and is where most breakoffs occur.

### Operation

To retrieve baits or lures that are hung below or above the surface is a simple step-by-step operation.

1. Attach the bait retriever/hook remover to any extension pole of your choice. Most of these poles have a simple screw on male adapter.
2. Hold the fishing line with one hand against the rod part of the retriever and wrap the fishing line around the coil three times with the other hand. This will keep the fishing line completely encased inside of the coil to protect it and will enable it to slide up and down the line freely.
3. Hold the fishing line in one hand to keep slight tension on it and hold the pole in the other hand.
4. The fishing line is encased inside the coil and it will guide the retriever to the front of the hung lure or hook as you push the retriever towards the hung lure.
5. Very little pressure is needed to push the bait free from the object on which it is hung.
6. This is where the bend in the rod becomes very important. The bend in the rod allows pressure to be applied downward as well as backward to release the hung bait more easily.
7. After the bait is freed from the object on which it is hung, you simply keep slight tension on the line to keep the bait close to the coil as you bring the extension pole back into the boat.
8. When the bait is back in the boat, you simply hold the line against the rod and unwind the line from around the coil.
9. This same procedure can be used to release fish while they are still in the water.
10. Most of these extension poles extend up to twelve feet or more. This enables the fisherman to be a greater and safer distance from these large fish than the standard release mechanisms that are on the market today.
11. To release fish that have been caught and put in the boat, take the retriever/hook remover off the extension pole and place one foot on the line between rod tip and the fish to keep slight tension on the line.
12. While holding the fish by the mouth use the other hand to wrap the coil around the line and push it down into the throat of the fish where the hook is embedded.
13. After the hook has been pushed free put a finger on the line and hold it against the rod. This will keep the hook close to the coil and keep it from reengaging in the fish's mouth. This procedure works extremely well when removing soft plastic baits which the fish tends to try to swallow before it is hooked.
14. This method of dehooking the fish is less likely to cause serious injury to the fish than using long needle nose pliers which many fisherman use. This is very important in catch and release fishing.

1. A bait retriever/hook remover comprising:
A. A rigid metal rod molded into a hard plastic or metal handle. This rod could possibly be made from some hard plastic, fiberglass or other rigid material.
B. The handle has the ability to attach to any standard extension pole. These poles usually have a male adapter on its end to attach tools to it.
C. The rigid rod is coiled on the end of the rod opposite the handle.
